(19) United States
(12) Patent Application Publication
(10) Pub. No.: US 2015/0077905 A1
(43) Pub. Date: Mar. 19, 2015

(54) SOLID ELECTROLYTIC CAPACITOR

(71) Applicant: SAMSUNG ELECTRO-MECHANICS CO., LTD., Suwon-Si (KR)

(72) Inventors: Hong Kyu SHIN, Suwon-Si (KR); Jae Bum CHO, Suwon-Si (KR); Wan Suk YANG, Suwon-Si (KR); Hyun Sub OH, Suwon-Si (KR)

(21) Appl. No.: 14/485,622

(22) Filed: Sep. 12, 2014

(30) Foreign Application Priority Data
Sep. 16, 2013 (KR) 10-2013-0111347

(51) Int. Cl. H01G 9/052; H01G 9/08; H01G 9/15

(52) U.S. Cl. CPC H01G 9/0525; H01G 9/15; H01G 9/08
USPC 361/529

(57) ABSTRACT

A solid electrolytic capacitor may include: a capacitor body containing a tantalum powder and having a tantalum wire formed on one end portion thereof; a mounting board formed on a lower surface of the capacitor body and including an insulating layer and wiring layers formed on an upper surface and a lower surface of the insulating layer; a side electrode contacting an end portion of the tantalum wire and connected to the wiring layers of the mounting board; and a molding part enclosing the capacitor body and the tantalum wire. The mounting board may have a via electrode penetrating through the insulating layer and electrically connecting the wiring layers formed on the upper surface and the lower surface of the insulating layer.

### CROSS-REFERENCE TO RELATED APPLICATION

This application claims the benefit of Korean Patent Application No. 10-2013-0111347 filed on Sep. 16, 2013, with the Korean Intellectual Property Office, the disclosure of which is incorporated herein by reference.

### BACKGROUND

The present disclosure relates to a solid electrolytic capacitor, and more particularly, to a solid electrolytic capacitor having excellent equivalent series resistance (ESR) properties, and improved capacitance and adhesion properties.

A solid electrolytic capacitor is an electronic component used to block a direct current and allow an alternating current to pass therethrough as well as to accumulate electricity. Among types of the solid electrolytic capacitor described above, typically, a tantalum capacitor is manufactured.

A capacitor is a component in which two flat plate electrodes insulated from each other are disposed to be adjacent to each other, a dielectric body is inserted between the two flat plate electrodes, and electrical charges are accumulated by attractive force, and is used to obtain a capacitance by confining electrical charges and electrical fields in a space enclosed by two conductors.

A tantalum capacitor according to the related art has a structure in which an internal lead frame is formed, or a terminal is exposed outwardly without a frame, in order to connect a tantalum material and an electrode to each other.

In case of the structure using an internal lead frame, the space occupied by a tantalum material in a molding part may be decreased by the lead frame forming a positive electrode and a negative electrode. Further, since a capacitance is proportional to a volume of the tantalum material, the capacitance may be restricted.

Meanwhile, in case of the structure in which a terminal is exposed outwardly without a frame, for reasons such as the need to secure a welding distance in which a solder for joining a negative electrode lead frame disposed on the side of the capacitor to a tantalum material, is formed, an internal volume of the tantalum material was decreased, thereby limiting an improvement of capacitance, and as materials to be contacted were present in a large number, contact resistance was increased by a plurality of materials to be contacted, thereby increasing ESR of a capacitor.

In addition, since a positive electrode wire was directly led-out and connected to an external terminal, a contact area therebetween was decreased, thereby increasing sheet resistance, and increasing a separation phenomenon.

### RELATED ART DOCUMENT

(Patent Document 1) Korean Patent Laid-Open Publication No. 2010-0065596

### SUMMARY

An exemplary embodiment in the present disclosure may provide a solid electrolytic capacitor allowing for the implementation of low equivalent series resistance (ESR) by decreasing ESR while improving capacitance, without forming an internal lead frame, as well as allowing for improved adhesion properties due to a decrease in sheet resistance.

According to an exemplary embodiment in the present disclosure, a solid electrolytic capacitor may include: a capacitor body containing a tantalum powder and having a tantalum wire formed on one end portion thereof; a mounting board formed on a lower surface of the capacitor body and including an insulating layer and wiring layers formed on an upper surface and a lower surface of the insulating layer; a side electrode contacting an end portion of the tantalum wire and connected to the wiring layers of the mounting board; and a molding part enclosing the capacitor body and the tantalum wire, wherein the mounting board has a via electrode penetrating through the insulating layer and electrically connecting the wiring layers formed on the upper surface and the lower surface of the insulating layer.

The mounting board may have a plurality of via electrodes having a diameter of 50 to 200 μm.

The insulating layer may have a thickness of 30 to 50 μm.

The wiring layers may have thicknesses of 4 to 10 μm.

The tantalum wire may be formed in a lower portion of the capacitor body, lower than a central portion of the capacitor body.

A conductive paste may be formed between the capacitor body and the wiring layer on the upper surface of the insulating layer, to electrically connect the capacitor body and the wiring layer on the upper surface of the insulating layer.

According to an exemplary embodiment in the present disclosure, a solid electrolytic capacitor may include: a capacitor body containing a tantalum powder and having a tantalum wire formed on one end portion thereof; a mounting board formed on a lower surface of the capacitor body and including an insulating layer and wiring layers formed on an upper surface and a lower surface of the insulating layer; a conductive paste formed between the tantalum wire and the wiring layer on the upper surface of the insulating layer, to electrically connect the tantalum wire and the mounting board to each other; and a molding part enclosing the capacitor body and the tantalum wire, wherein the mounting board has a via electrode penetrating through the insulating layer and electrically connecting the wiring layers formed on the upper surface and the lower surface of the insulating layer.

The mounting board may have a plurality of via electrodes having a diameter of 50 to 200 μm.

The tantalum wire may be formed in a lower portion of the capacitor body, lower than a central portion of the capacitor body.

A conductive paste may be formed between the capacitor body and the wiring layer on the upper surface of the insulating layer, to electrically connect the capacitor body and the wiring layer on the upper surface of the insulating layer.

The conductive paste may contain one or more selected from the group consisting of silver (Ag), gold (Au), lead (Pb), nickel (Ni) and copper (Cu).

The solid electrolytic capacitor may further include: a side electrode connected to at least one of the capacitor body and the tantalum wire, and connected to the wiring layers of the mounting board.

### BRIEF DESCRIPTION OF DRAWINGS

The above and other aspects, features and other advantages in the present disclosure will be more clearly understood from the following detailed description taken in conjunction with the accompanying drawings, in which:

FIG. 1 is a transparent perspective view showing a schematic structure of a solid electrolytic capacitor according to an exemplary embodiment in the present disclosure;

FIG. 2 is a cross-sectional view taken along line A-A′ of FIG. 1;

FIG. 3 is a cross-sectional view of the solid electrolytic capacitor according to an exemplary embodiment in the present disclosure; and

FIG. 4 is a cross-sectional view of the solid electrolytic capacitor according to an exemplary embodiment in the present disclosure.

### DETAILED DESCRIPTION

Exemplary embodiments in the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

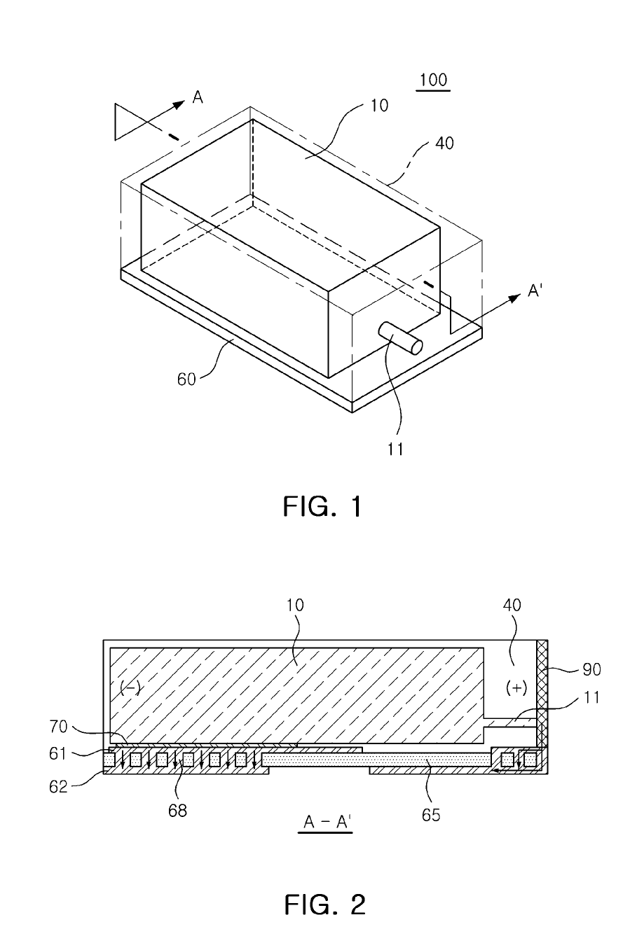

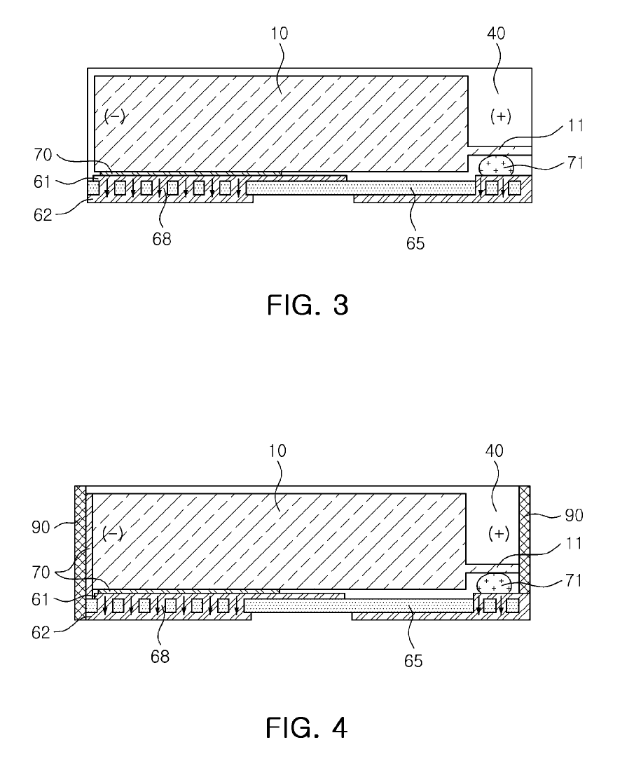

FIG. 1 is a transparent perspective view showing a schematic structure of a solid electrolytic capacitor according to an exemplary embodiment in the present disclosure. FIG. 2 is a cross-sectional view taken along line A-A′ of FIG. 1. FIG. 3 is a cross-sectional view of the solid electrolytic capacitor according to an exemplary embodiment in the present disclosure. FIG. 4 is a cross-sectional view of the solid electrolytic capacitor according to an exemplary embodiment in the present disclosure.

Referring to FIGS. 1 through 4, a solid electrolytic capacitor 100 according to an exemplary embodiment in the present disclosure may include a capacitor body 10, a tantalum wire 11 formed on one end portion of the capacitor body, a molding part 40 enclosing the capacitor body and the tantalum wire, and a mounting board 60 on which the capacitor body is mounted.

The capacitor body 10 may be formed of a tantalum material, and be formed by sintering. Further, the capacitor body 10 may be formed to have a rectangular parallelepiped shape, and include the tantalum wire 11 having positive polarity and led-out to one end portion of the capacitor body 10.

The capacitor body 10 may be manufactured, for example, by mixing a tantalum powder and a binder at a predetermined ratio, stirring and compressing the mixture to form a rectangular parallelepiped shape, and then performing sintering thereon at high temperature.

In this case, before the mixture of the tantalum powder and the binder is compressed, the tantalum wire 11 may be inserted into the mixture of the tantalum powder and the binder such that the tantalum wire 11 may be eccentric from the center of the capacitor body 10.

That is, the capacitor body 10 may be manufactured by inserting the tantalum wire 11 into the tantalum powder mixed with the binder to form a tantalum element having a desired size and then sintering the tantalum element at about 1,000 to 2,000° C. under high vacuum atmosphere (10⁻⁵ torr or less) for about 30 minutes.

The capacitor body 10 may have a negative electrode layer of manganese dioxide (MnO₂) formed on an outer surface thereof, in order to implement negative polarity. Further, a negative electrode reinforcing layer on which carbon and silver (Ag) are coated, may be further formed on an outer surface of the negative electrode layer. In this case, carbon may be provided to decrease contact resistance in the surface of the capacitor body 10, and silver (Ag), a material having high electrical conductivity, may be generally used in the art in order to form a conductive layer. However, the present disclosure is not limited thereto.

In the drawings related to the capacitor body 10, the indication of the negative electrode layer and the negative electrode reinforcing layer, and the reference numerals thereof will be omitted, since configurations thereof were determined to be techniques commonly known in the art and fully understandable to a person skilled in the art without the indication thereof in the drawings at the time of manufacturing the solid electrolytic capacitor according to an exemplary embodiment in the present disclosure.

The molding part 40 may be formed by molding a resin to enclose the capacitor body 10 in a state in which an end portion of the tantalum wire 11 is exposed.

The mounting board 60 may be provided on a lower surface of the capacitor body 10 to be electrically connected to the negative electrode and the positive electrode.

The mounting board 60 may include an insulating layer 65 and wiring layers 61 and 62 formed on the upper surface and the lower surface of the insulating layer, and the wiring layers 61 and 62 formed on the upper surface and the lower surface of the insulating layer 65 may be electrically connected to each other by via electrodes 68 penetrating through the insulating layer 65.

By mounting the capacitor body 10 on the mounting board 60, rather than forming an internal lead frame according to the related art, an internal volume of the tantalum material may be increased, a capacitance may be improved, and a current may flow internally and directly through the via electrodes 68, such that low equivalent series resistance (ESR) may be implemented.

Here, the insulating layer 65 may contain fiber-glass, an epoxy resin, or the like, but is not limited thereto, and have a thickness of 30 to 50 μm.

The wiring layers 61 and 62 formed on the upper surface and the lower surface of the insulating layer 65 may contain a conductive metal such as copper (Cu), nickel (Ni), gold (Au)or the like, and may be formed by performing an etching process after forming a thin film layer through a process such as physical vapor deposition (PVD). The wiring layer 61 formed on the upper surface of the insulating layer 65 may form positive and negative internal electrodes, and the wiring layer 62 formed on the lower surface of the insulating layer 65 may form positive and negative external electrodes. The wiring layers 61 and 62 may have thicknesses of 4 to 10 μm.

The insulating layer 65 may have a plurality of the via electrodes 68 penetrating through the insulating layer 65 to connect the wiring layer 61 forming the internal electrode (hereinafter, referred to as “internal electrode wiring layer 61”) on the upper surface of the insulating layer 65 and the wiring layer 62 forming the external electrode on the lower surface of the insulating layer 65.

The via electrodes 68 may be manufactured by forming holes in the insulating layer 65 through a punching process or a laser drilling process, and filling the holes with a conductive paste such as copper (Cu), silver (Ag), or the like. The via electrodes may have a diameter of 50 to 200 μm.

The capacitor body 10 of the negative electrode part may be coupled to the internal electrode wiring layer 61 on the upper surface of the insulating layer 65 by a conductive paste layer 70, thereby being electrically connected thereto.

The conductive paste layer 70 maybe formed of a viscous conductive paste containing silver (Ag), gold (Au), lead (Pb), nickel (Ni), copper (Cu), or the like, and be formed by applying the paste to a portion of the lower surface of the capacitor body 10 of the negative electrode part and hardening the paste at a temperature of about 30 to 300° C.

The tantalum wire 11 of the positive electrode part may be connected to a side electrode 90 connected to the wiring layers 61 and 62 of the mounting board 60 (see FIG. 2). The tantalum wire 11 maybe formed in a lower portion of the capacitor body lower than a central portion of the capacitor body 10, in order to decrease sheet resistance and improve adhesion properties.

Meanwhile, according to another exemplary embodiment in the present disclosure, the tantalum wire 11 may be connected directly to the internal electrode wiring layer 61 formed on the upper surface of the insulating layer 65 by a conductive paste 71 (see FIG. 3).

Thus, the tantalum wire 11 and the internal electrode wiring layer 61 may be electrically connected to each other by the conductive paste 71, such that all electrodes may pass through only within the capacitor to allow for a reduced ESR. Further, it is unnecessary to form a side electrode, which contributes to process simplification. In addition, as a contact area with the electrodes is increased, sheet resistance may be decreased, and adhesion properties may be improved.

The conductive paste 71 may contain a conductive metal the same as that of the conductive paste layer 70 connecting the capacitor body 10 of the negative electrode part to the internal electrode wiring layer 61 and for example, may contain silver (Ag), gold (Au), lead (Pb), nickel (Ni), copper (Cu), or the like.

Further, in an exemplary embodiment in the present disclosure, the solid electrolytic capacitor may further include the side electrode 90 connecting the tantalum wire 11 and the internal electrode wiring layer 61 to each other by the conductive paste 71 and formed to be connected to at least one of the capacitor body 10 of the negative electrode part and the tantalum wire 11 of the positive electrode part and to be connected to the wiring layers 61 and 62 of the mounting board 60 (see FIG. 4).

According to the configuration as described above, increases in a current path may be realized in four directions of the via electrodes of the negative and the positive electrodes and the side electrodes, such that ESR may be further reduced.

As set forth above, according to exemplary embodiments in the present disclosure, a solid electrolytic capacitor allowing for the implementation of low equivalent series resistance (ESR) by decreasing ESR while improving capacitance, without forming an internal lead frame, as well as allowing for improved adhesion properties due to a decrease in sheet resistance may be provided.

While exemplary embodiments have been shown and described above, it will be apparent to those skilled in the art that modifications and variations could be made without departing from the scope of the present invention defined by the appended claims.

1. A solid electrolytic capacitor comprising:
a capacitor body containing a tantalum powder and having a tantalum on one end portion;
a mounting board disposed on a lower surface of the capacitor body and including an insulating layer and wiring layers on an upper surface and a lower surface of the insulating layer;
a side electrode contacting an end portion of the tantalum wire and connected to the wiring layers of the mounting board; and
a molding part enclosing the capacitor body and the tantalum wire,
wherein the mounting board has a via electrode penetrating through the insulating layer and electrically connecting the wiring layers disposed on the upper surface and the lower surface of the insulating layer.

2. The solid electrolytic capacitor of claim 1, wherein the mounting board has a plurality of via electrodes having a diameter of 50 to 200 μm.

3. The solid electrolytic capacitor of claim 1, wherein the insulating layer has a thickness of 30 to 50 μm.

4. The solid electrolytic capacitor of claim 1, wherein the wiring layers have thicknesses of 4 to 10 μm.

5. The solid electrolytic capacitor of claim 1, wherein the tantalum wire is formed in a lower portion of the capacitor body, lower than a central portion of the capacitor body.

6. The solid electrolytic capacitor of claim 1, wherein a conductive paste is formed between the capacitor body and the wiring layer on the upper surface of the insulating layer, to electrically connect the capacitor body and the wiring layer on the upper surface of the insulating layer.

7. A solid electrolytic capacitor comprising:
a capacitor body containing a tantalum powder and having a tantalum wire on one end portion;
a mounting board disposed on a lower surface of the capacitor body and including an insulating layer and wiring layers on an upper surface and a lower surface of the insulating layer;
a conductive paste disposed between the tantalum wire and the wiring layer on the upper surface of the insulating layer, to electrically connect the tantalum wire and the mounting board to each other; and
a molding part enclosing the capacitor body and the tantalum wire,
wherein the mounting board has a via electrode penetrating through the insulating layer and electrically connecting the wiring layers disposed on the upper surface and the lower surface of the insulating layer.

8. The solid electrolytic capacitor of claim 7, wherein the mounting board has a plurality of via electrodes having a diameter of 50 to 200 μm.

9. The solid electrolytic capacitor of claim 7, wherein the tantalum wire is formed in a lower portion of the capacitor body, lower than a central portion of the capacitor body.

10. The solid electrolytic capacitor of claim 7, wherein a conductive paste is formed between the capacitor body and the wiring layer on the upper surface of the insulating layer, to electrically connect the capacitor body and the wiring layer on the upper surface of the insulating layer.

11. The solid electrolytic capacitor of claim 7, wherein the conductive paste contains one or more selected from the group consisting of silver (Ag), gold (Au), lead (Pb), nickel (Ni) and copper (Cu).

12. The solid electrolytic capacitor of claim 7, further comprising: a side electrode connected to at least one of the capacitor body and the tantalum wire, and connected to the wiring layers of the mounting board.

13. The solid electrolytic capacitor of claim 10, wherein the conductive paste contains one or more selected from the group consisting of silver (Ag), gold (Au), lead (Pb), nickel (Ni) and copper (Cu).
